(19) United States
(12) Patent Application Publication
(10) Pub. No.: US 2003/0177078 A1
(43) Pub. Date: Sep. 18, 2003

(54) Method and structure for the privatization of military housing communities

(75) Inventors: Peter A. Koziol, Napa, CA (US); Gary M. Buechler, Towaco, NJ (US); John A. Garraty JR., New York, NY (US)

Correspondence Address: DARBY & DARBY P.C., Post Office Box 5257, New York, NY, 10150-5257, US

(73) Assignee: Actus Lend Lease LLC

(21) Appl. No.: 10/309,953

(22) Filed: Dec. 4, 2002

Related U.S. Application Data
(60) Provisional application No. 60/337,628, filed on Dec. 5, 2001.

(51) Int. Cl. G06F 17/60

(52) U.S. Cl. 705/35

(57) ABSTRACT

A method and system for structuring the privatization of the development, management and ownership of one or more military housing communities. The method and system minimizes the amount of revenue generated by the privatization of military family housing which is subject to Federal, state and/or local income tax in order to permit a greater percentage of such revenue to be devoted to the development, management and ownership of the privatized military housing communities for the benefit of the U.S. Government and the military personnel and, in certain circumstances, family members that do or will reside in such communities.

This patent application claims priority under 35 U.S.C. § 119 from U.S. Provisional Application Serial No. 60/337,628 filed Dec. 5, 2001, entitled Method And Structure For The Privatization Of military housing communities, the entitety of which is hereby incorporated by reference.

### BACKGROUND OF THE INVENTION

There are a number of military housing communities that have been erected across the United States and its territories. These communities include residence units and common grounds that must be maintained to continue to be an attractive housing choice for personnel of the U.S. armed forces. The range of issues presented by such communities suggests that privatization of the development, management and ownership is desirable, and indeed several communities have been privatized to free the Government of such responsibilities. The structure of the privation is complicated, and bidders on the Government contracts awarding the privatization of the development, management and ownership of one or more military housing communities have to account for their profits and for the taxes that have to be paid to fund the ongoing needs of the privatized community. There is a need to minimize the amount of revenue generated by the privatization of military family housing that is subject to Federal, state and/or local income tax in order to permit a greater percentage of such revenue to be devoted to the development, management and ownership of the privatized community. The present invention satisfies these and other needs.

### SUMMARY OF THE INVENTION

In accordance with one aspect of the invention, a method for structuring the privatization of the development, management and ownership of one or more military housing communities (MFC) included on a parcel of real property is disclosed. The MFC includes housing for occupancy primarily by arbitrary number, N, service personnel of a branch of the U.S. armed forces and, in certain circumstances, their families. The method comprises the steps of: forming a limited liability entity (LLE) having at least two owners including the relevant branch of the U.S. armed forces (to that MFC) and at least one private sector entity; allocating to each private sector entity a percentage of any income collected by the LLE which correlates directly with the actual amount of income distributed to each said private sector entity; providing the LLE with a real-property interest in the parcel and any improvements thereto; capitalizing the LLE with at least one of cash and an in-kind contribution from the owners; collecting as income to the LLE a basic allowance for housing (BAH) for each of the N service personnel occupying the MFC; and covering expenses associated with developing and managing the MFC included on the parcel using a portion of the collected income.

In accordance with a further aspect of the invention, a community development and management plan (CDMP) is provided in response to a request for qualifications issued in connection with a military housing privatization initiative in which the development, management and ownership of one or more military housing communities (MFC) on a parcel of land is to be privatized. The MFC includes housing for occupancy primarily by arbitrary number, N, service personnel of a branch of the U.S. armed forces and, in certain circumstances, their families. The CDMP comprises: the formation of a limited liability entity (LLE) having at least two owners including the branch of the U.S. armed forces and at least one private sector entity; the allocation to the each said private sector entity a percentage of any income collected by the LLE, the percentage correlating directly with an actual amount of income distributed to each said one private sector entity; the provision to the LLE of a real-property interest in the parcel and any improvements thereto; the capitalizing of the LLE with at least one of cash and an in-kind contribution from each of the owners; the collection as income to the LLE a basic allowance for housing (BAH) for each of the N service personnel that shall occupy the housing in the MFC; and the recovery of expenses associated with development and management of the MFC included on the parcel using a portion of any undistributed income.

In a related aspect, the invention can be implemented in deals that do not involve a CDMP. Generally, a deal can be structured as described above in response to a request (e.g., a request for proposal, a request for qualifications, or a request for quote), regardless of whether there is a CDMP or not. Thus, for example, the structured deal in response to the request is to implement the MFC.

These and further features, aspects, and methodologies can be appreciated from the following description of the Brief Description of the Drawing FIGURES and the Detailed Description of an Exemplary Embodiment.

### BRIEF DESCRIPTION OF THE DRAWING FIGURES

FIG. 1 illustrates a flow diagram illustrating the methodology of the present invention.

### DETAILED DESCRIPTION OF AN EXEMPLARY EMBODIMENT

Generally, the present invention provides for a business method for structuring the privatization of the development, management and/or ownership of one or more military housing communities (“privatization project”), including housing for occupancy primarily by service personnel of a branch of the U.S. armed forces and, in certain circumstances, their families. The method minimizes the amount of revenue generated by the privatization project that is subject to Federal, state and/or local income tax in order to permit a greater percentage of such revenue to be devoted to the project itself for the ultimate benefit of the U.S. Government and the military personnel and any family members that do or will reside in such communities.

The structure involves including the United States or an agency thereof (“government”) as an owner of the entity that acts as the privatization contractor (the “privatization contractor”). The term “owner,” as used herein, refers to a partner/shareholder, member or the like. Special allocations of items of income and/or deductions are made among the owners of the privatization contractor so that each of the private sector owners are, in general, allocated income in an amount that does not exceed the amount of the cash distributions that are made to that owner. All other income of the privatization contractor shall be allocated to the government so that such monies will be available for use in connection with the privatization project without reduction by the payment of income taxes thereon.

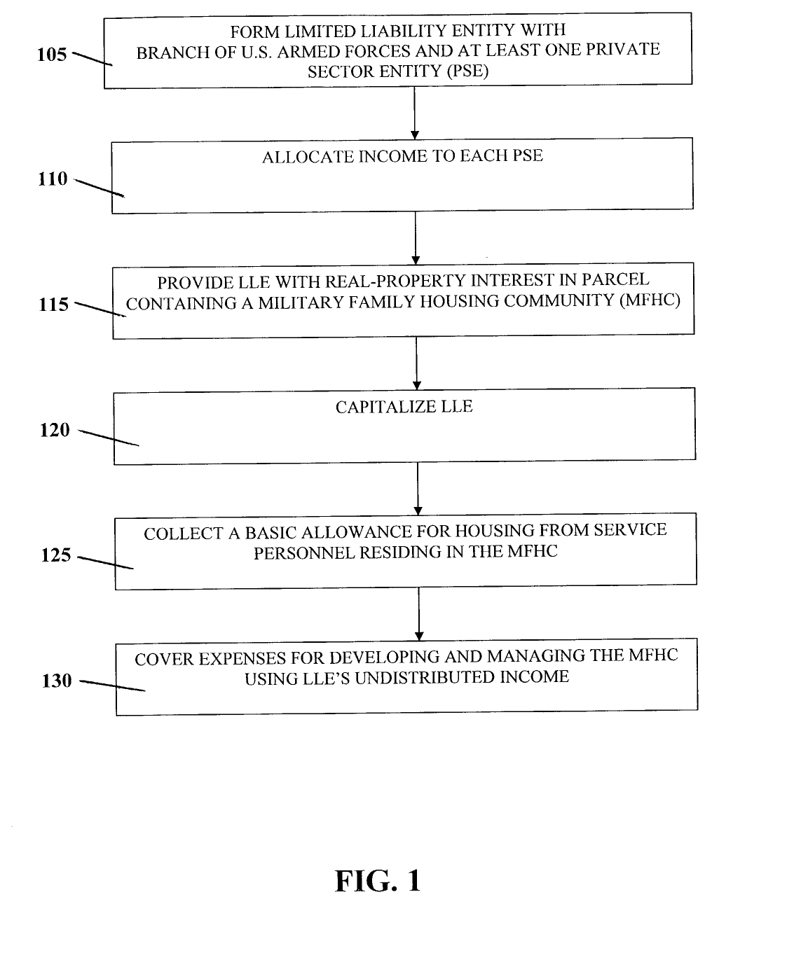

By way of overview and introduction, FIG. 1 illustrates a method for structuring a privatization project of the type that includes development, management and ownership of one or more military housing communities included on a parcel of real property. The housing units are for occupancy primarily by service personnel of a branch of the U.S. armed forces and, in certain circumstances, their families.

First, a privatization contractor, or a limited liability entity (LLE) must be formed (Step 105). The LLE must have at least two owners, one of which is a branch of the U.S. armed forces and at least another of which is a private sector entity.

Second, in the LLE's operating agreement or other governing instrument, each private sector entity must be allocated a percentage of the income collected by the LLE (Step 110). This percentage of income equals, generally, the actual amount of income distributed to such private sector entity.

Third, the LLE must be provided with a real property interest in a parcel of real property and improvements (Step 115). The parcel of real property must contain at least one military housing community. The LLE's interest may be obtained as an in-kind contribution of property by the branch of the U.S. armed forces.

Fourth, the LLE must be capitalized with cash and/or in-kind contributions from the owners (Step 120).

Fifth, the LLE must collect, as income, a basic allowance for housing (BAH) for each of the service personnel occupying the housing in the military housing community (Step 125).

Lastly, at least some expenses associated with developing and managing the military housing community must be covered using a portion of the LLE's undistributed income (Step 130).

Additionally, income may be distributed to the private sector entity so as to satisfy a prescribed rate of return.

Moreover, the method preferably includes the step of allocating to the branch of the U.S. armed forces, in the operating agreement, a percentage of income which is reduced from 100% by the percentage allocated to the private sector entity or entities. Additionally, the branch of the U.S. armed forces may be allocated a percentage share of voting rights in the LLE, where the percentage of income is disproportionately large compared to the percentage share of voting rights.

Under the ownership structure discussed above, income allocated to the branch of the U.S. armed forces may be free of federal income taxation and is available for use in the development, management and operation of the applicable military housing community. Likewise, some, or all, of the portion of income allocated to the branch of the U.S. armed forces may be invested in a reserve account which would earn interest free of federal income taxation. Similarly, the LLE may be a pass-through entity for minimizing any tax consequences in privatizing the applicable military housing community.

Optionally, the LLE may have an operating agreement or other governing instrument that specifies income sharing, voting rights, and a tax allocation among the owners. What is more, the prescribed rate of return may include at least one of a specified preferred return and an additional return above that specified return.

The branch of the U.S. armed forces includes a member selected from the group of the army, air force, navy, marines, and coast guard. Although, one of ordinary skill in the art will recognize that the U.S. may, pursuant to Congressional mandate, create additional branches of the armed forces, and that the present invention should not be construed to be limited to those branches of armed forces currently in service by the U.S government.

The branch of the U.S. armed forces may also be an owner of the LLE.

Additionally, the remainder of any income may be spent on the development and management of the applicable military housing community. Also, the LLE's operating agreement may allocate a majority of the income to the branch of the U.S. armed forces. Accordingly, the operating agreement may specify that a percentage of income allocated to the branch of the U.S. armed forces must be used to cover expenses associated with developing, managing and operating the applicable military housing community, and additionally, specifies the prescribed rate of return for the private sector entity.

In an alternative embodiment, and in response to a request for qualifications issued in connection with a military housing privatization initiative project in which the development, management and ownership of one or more military housing communities (including housing for occupancy primarily by service personnel of a branch of the U.S. armed forces and, sometimes, their families) is to be privatized, the present invention may provide for the creation of a community development and management plan (CDMP).

The CDMP must first provide for the formation of a Privatization Contractor, or LLE (Step 105). The LLE must have at least two owners, one of which is a branch of the U.S. armed forces and at least another of which is a private sector entity.

Second, the CDMP specifies that in the LLE's operating agreement, each private sector entity must be allocated a percentage of the income collected by the LLE (Step 110). This percentage of income equals, generally, the actual amount of income distributed to such private sector entity.

Third, the CDMP specifies that the LLE must be provided with a real property interest in a parcel of real property and improvements (Step 115). The parcel of real property must contain at least one military housing community. The LLE's interest may be obtained as an in-kind contribution of property by the branch of the U.S. armed forces.

Fourth, the CDMP specifies that the LLE must be capitalized with cash and/or in-kind contributions from the owners (Step 120).

Fifth, the CDMP specifies that the the LLE must collect, as income, a basic allowance for housing (BAH) for each of the service personnel occupying the housing in the military housing community (Step 125).

Lastly, at least some expenses associated with developing and managing the military housing community must be covered using a portion of the LLE's undistributed income (Step 130).

### EXAMPLE

By way of example, and in connection with the a typical real estate closing for a military housing community included on a parcel of real property, the following documents may be prepared in accordance with the present invention:

(a) Participation Agreement;

(b) Partnership Agreement;

(c) Ground Lease; and

(d) Business Agreement.

These documents, in relevant part, are reprinted below.

### PARTICIPATION AGREEMENT

THIS PARTICIPATION AGREEMENT (this “Agreement”), dated as of Nov. 1, 2001 (the “Financial Closing Effective Date”), by and among REDACTED LP, a Texas limited partnership (the “Partnership”), REDACTED INC., a Texas corporation (“General Partner”), ACTUS LEND LEASE LLC, a Delaware limited liability company (“ALL”), REDACTED LLC, a Delaware limited liability company (“REDACTED”), REDACTED, a Delaware limited partnership (“Property Manager”), REDACTED a Delaware limited liability company (“REDACTED-BM”), REDACTED, a Delaware limited partnership (“Business Manager”), REDACTED, a Delaware limited partnership (“Development Manager”), REDACTED a Delaware limited partnership (“Owner Participant”), REDACTED, a Delaware banking corporation (“Owner Trustee”), in its individual capacity to the extent expressly provided herein and otherwise solely in its capacity as trustee under that certain Trust Agreement (REDACTED Trust No. 1) dated as of Nov. 1, 2001, THE UNITED STATES OF AMERICA by THE SECRETARY OF THE ARMY (the “Army”), REDACTED a Florida corporation (“Loan Placement Agent”), REDACTED, in its individual capacity to the extent expressly provided herein and otherwise solely in its capacity as trustee under the Indenture (in such capacity, the “Indenture Trustee”), and as cash management agent under the Lock Box Agreement (in such capacity, the “Cash Management Agent”), and REDACTED, a French banking corporation acting through its New York Branch (“Initial Bond Purchaser”).

### RECITALS

A. On Aug. 6, 1999, the Army issued the RFQ;

B. In response to the RFQ, ALL and TCR, jointly submitted the SOQ;

C. General Partner (as general partner), ALL and TCR (each as limited partners) have formed the Partnership (formerly known as REDACTED) by causing to be filed the Partnership Certificate;

D. The Partnership has succeeded to all of the respective rights of ALL and TCR under the SOQ;

E. REDACTED has succeeded to all of the rights of ALL in and to the Partnership as a limited partner;

F. REDACTED has succeeded to all of the rights of TCR in and to the Partnership as a limited partner;

G. Pursuant to the Award, the Army awarded the Partnership a contract to prepare a CDMP for the Installation;

H. Pursuant to that certain Amendment of Solicitation/Modification of Contract, dated Jun. 8, 2001, Congress granted its approval of the CDMP and the Army authorized the Partnership to proceed to consummate the transactions contemplated by the CDMP by issuing the Notice to Proceed;

I. The parties hereto desired and intended to consummate the Overall Transaction as of Oct. 1, 2001, but based upon the events of Sep. 11, 2001, including the terrorist attacks on the World Trade Center and the Pentagon and including the effects of such events upon the United States casualty insurance markets, in order to effectuate the privatization of the housing facilities pursuant to the RFQ, the SOQ, the CDMP and the Notice to Proceed and in accordance with the RCI Program and the MHPI Act, the parties bifurcated the Overall Transaction and the Partnership, the Army, ALL and REDACTED, solely in its capacity as Cash Management Agent, consummated the acquisition closing element of the Overall Transaction, including the Army's conveyance of the Land, the Improvements and the Personal Property (in fee and/or leasehold) to the Partnership and the Army's admittance into the Partnership as of Oct. 1, 2001;

J. In order to effectuate the privatization of the housing facilities pursuant to the RFQ, the SOQ, the CDMP and the Notice to Proceed and in accordance with the RCI Program and the MHPI Act and, subject to the terms of this Agreement, the parties hereto wish to consummate the portions of the Overall Transaction not effectuated pursuant to the Acquisition Closing, enter into, as of the Financial Closing Effective Date, the remaining Operative Documents and amend certain of the Operative Documents entered into as of the Acquisition Closing; and

K. The parties hereto desire to enter into this Agreement in order to undertake certain obligations with respect to, and to establish certain conditions precedent to, the closing of the Overall Transaction and the effectuation of the transactions contemplated pursuant to this Agreement and the Operative Documents.

NOW, THEREFORE, for valuable consideration, the receipt and sufficiency of which are hereby acknowledged, the parties hereby agree as follows:

### ARTICLE II

### Participation by Parties Hereto

Section 2.1Acquisition Closing. Subject to the terms and conditions of that certain Interim Agreement dated as of Oct. 1, 2001, by and among the Partnership, the Army, ALL and Cash Management Agent, the following transactions were consummated on or about Oct. 1, 2001:

(a) the Army was admitted to and joined the Partnership as a limited partner;

(b) the General Partner, REDACTED, REDACTED and the Army executed and delivered the Partnership Agreement;

(c) ALL loaned the amount of REDACTED ($REDACTED) to the Partnership (the “ALL Loan”);

(d) the Partnership executed and delivered that certain Note dated as of Oct. 1, 2001, by the Partnership in favor of ALL to evidence the ALL Loan;

(e) the Partnership executed and delivered that certain Deed of Trust effective as of Oct. 1, 2001, by the Partnership in favor of REDACTED as trustee for the benefit of ALL (“ALL Deed of Trust”);

(f) the Army, as ground lessor, and the Partnership, as ground lessee, executed and delivered the Ground Lease with respect to the Land;

(g) the Army, as ground lessor, and the Partnership, as ground lessee, executed and delivered the Memorandum of Ground Lease with respect to the Ground Lease;

(h) the Army conveyed fee simple title with a right of reversion in and to the Improvements to the Partnership pursuant to the Deed;

(i) the Army conveyed ownership in and to the Personal Property to the Partnership pursuant to the Bill of Sale;

(j) the Partnership and the Army executed and delivered the Business Agreement;

(k) the Partnership and the Army executed and delivered the Municipal Services Agreement;

(l) the Partnership, the General Partner, the Army and the Cash Management Agent, executed and delivered the Lock Box Agreement;

(m)the Partnership and Business Manager executed and delivered the Management Agreement;

(n) Business Manager and Property Manager executed and delivered the Property Management Agreement;

(o) Business Manager and REDACTED, a Delaware limited liability company, executed and delivered the Maintenance Agreement;

(p) the Partnership, the Army, ALL and the Cash Management Agent executed and delivered the Interim Agreement; and

(q) the Partnership and Development Manager executed and delivered the Development Services Agreement.

Section 2.2Participation by Parties Hereto in Financial Closing. Subject to the terms and conditions of this Agreement and the other Operative Documents, including the satisfaction (or waiver in writing or as otherwise provided in Section 4.1) of the conditions set forth in Article IV hereof, on the Financial Closing Effective Date the parties hereto shall cause the following transactions to be consummated in accordance with the provisions hereof:

(a) the General Partner, REDACTED, REDACTED and the Army shall enter into the amended and restated Partnership Agreement;

(b) the Army shall contribute in cash to the Partnership the amount of REDACTED ($REDACTED);

(c) The Partnership shall satisfy the ALL Loan by prepaying all principal and paying all accrued but unpaid interest and other amounts payable in connection therewith;

(d) REDACTED, as trustee under the ALL Deed of Trust shall execute and deliver a reconveyance of the ALL Deed of Trust which reconveyance shall be executed in proper form for recording in the real estate records of Bell and Coryell counties, Texas;

(e) Owner Participant and Owner Trustee shall enter into the Trust Agreement and Owner Participant shall transfer REDACTED ($REDACTED) to Owner Trustee pursuant to the Trust Agreement;

(f) Owner Trustee shall borrow the amount of REDACTED ($REDACTED) from the Tranche A Bond Holders, in accordance with the Tranche A Loan Documents;

(g) the Army, as ground lessor, and the Partnership, as ground lessee, shall enter into Supplement No. One, the amended and restated Ground Lease;

(h) the Partnership shall sublease the Land and lease the Residential Unit Improvements and the Personal Property to Owner Trustee pursuant to the Sublease;

(i) Owner Trustee shall prepay the rent due under the Sublease in an amount equal to REDACTED ($REDACTED), a portion of which shall be financed through the proceeds of the Tranche B Loan, in an amount equal to REDACTED ($REDACTED);

(j) Owner Trustee shall sub-sublease the Land, and sublease the Residential Unit Improvements and the Personal Property to the Partnership pursuant to the Bondable Lease;

(k) pursuant to the Bondable Lease, Owner Trustee shall provide the Partnership with REDACTED ($REDACTED) as a landlord's contribution towards the costs of tenant improvements for purposes of renovation, rehabilitation and demolition of certain of the existing Residential Unit Improvements and the construction of additional Residential Unit Improvements;

(l) the Partnership and ALL shall enter into the D&C Contract, pursuant to which ALL shall renovate, rehabilitate and demolish certain of the Improvements and construct certain Additional Improvements at the Property;

(m) ALL shall cause LLC to enter into the Construction Guaranty, pursuant to which LLC shall guarantee the payment by and the performance of the D&C Contractor under the D&C Contract;

(n) ALL shall enter into the ALL Guaranty, pursuant to which ALL shall guarantee the payment of the Additional Capital Contributions by the Private Sector Partners described in Section 2.3(b) below;

(o) the Partnership and the Army shall enter into the amended and restated Business Agreement;

(p) the Partnership, the General Partner, the Army, Owner Trustee, Cash Management Agent and the Indenture Trustee shall enter into the amended and restated Lock Box Agreement; and

(q) the other Operative Documents which were not executed in connection with the Acquisition Closing shall be executed by the respective parties thereto.

Section 2.3Additional Capital Contributions.

(a) General Partner may make Additional Capital Contributions to the Partnership in amounts equal to any liability incurred by General Partner as a result of, or by virtue of, its constituting a general partner of the Partnership.

(b) The Private Sector Partners shall, upon the earlier to occur of (i) thirty (30) days after the Final Completion Date, (ii) the fifth (5^{th}) anniversary of the Financial Closing Effective Date, (iii) thirty (30) days after LLC ceases to maintain an Investment Grade Credit Rating, or (iv) the occurrence of a Construction Balancing Call, to the extent funds are not otherwise available to the Partnership to pay such Construction Balancing Call, make the following Additional Capital Contributions respectively: (1) General Partner, REDACTED ($REDACTED); (2) REDACTED, REDACTED ($REDACTED); and (3) REDACTED, REDACTED ($REDACTED). All Additional Capital Contributions made pursuant to this Section 2.3(b) shall be paid directly to the Cash Management Agent pursuant to Section 3.2(b) of the Lock Box Agreement for application under Section 3.2(d) of the Lock Box Agreement.

(c) The Partners may make Additional Capital Contributions to the Partnership in accordance with Section 3.03 of the Partnership Agreement, at the time, and in amounts equal to the costs of improvements to be made to the Property from the proceeds of such Additional Capital Contributions (as such improvements and Additional Capital Contributions may be expressly authorized by the Partners as a Major Decision). All Additional Capital Contributions made by the Partners pursuant to Section 3.03(c) of the Partnership Agreement shall be deposited in the Lock Box Account and, as such, shall be subject to the limitations upon the use of the Project Reinvestment Reserve Subaccount as provided herein and in the Operative Documents.

(d) Except as otherwise provided in Section 3.03(a), (b) (c) and (d) of the Partnership Agreement, no Partner shall be permitted to make any Additional Capital Contribution to the Partnership without the express written consent of each other Partner. If any Additional Capital Contributions are to be made by a Partner pursuant to Section 3.03(e) of the Partnership Agreement, the Partners may at such time consider any amendments to the Partnership Agreement which may be appropriate to reflect the making of such Additional Capital Contributions by one or more of the Partners.

(e) Except as otherwise provided in Section 3.03(b) and (d) of the Partnership Agreement, no Limited Partner shall be required to make any Additional Capital Contributions to the Partnership.

The General Partner shall timely enforce the requirement of the Limited Partners to make the Additional Capital Contributions under Section 3.03 of the Partnership Agreement.

### ARTICLE III

### Financial Closing

Section 3.1Contemplated Transactions. Subject to the terms and conditions of this Agreement, on the Financial Closing Effective Date the parties hereto shall each perform their respective obligations under this Agreement to complete the transactions outlined below.

Section 3.2Reconstitution and Recapitalization of the Partnership. Subject to the terms and conditions of this Agreement, on the Financial Closing Effective Date:

(a) the General Partner, REDACTED, REDACTED and the Army shall enter into the amended and restated Partnership Agreement; and

(b) pursuant to the Partnership Agreement, the Army shall contribute in cash the amount of REDACTED ($REDACTED). For purposes of determining the total capital contribution of the Army to the Partnership, the value of the Ground Lease, the Improvements and the Personal Property is agreed to be equal to REDACTED ($REDACTED).

Section 3.3Execution of and Funding Under Trust Agreement. Subject to the terms and conditions of this Agreement, on or before the Financial Closing Effective Date:

(a) Owner Participant and the Owner Trustee shall execute and deliver the Trust Agreement and Owner Participant shall transfer REDACTED ($REDACTED) to the Owner Trustee pursuant to the Trust Agreement.

(b) the Tranche A Bond Holders shall fund the Tranche A Loan, less original issue discount, to the Owner Trustee in the amount of REDACTED ($REDACTED), to be evidenced by the Tranche A Bond and to be secured by the Tranche A Loan Documents.

(c) Owner Trustee shall issue the Tranche A Bond to the order of the Initial Bond Purchaser for an amount equal to REDACTED ($REDACTED), and execute and deliver the other Tranche A Loan Documents.

Section 3.4Partnership Loan to Owner Trustee. Subject to the terms and conditions of this Agreement, on the Financial Closing Effective Date the Partnership shall make the Tranche B Loan to the Owner Trustee in the amount of REDACTED ($REDACTED), and Owner Trustee shall execute and deliver to the Partnership the Tranche B Bond and other Tranche B Loan Documents.

Section 3.5Ground Lease. Subject to the terms and conditions of this Agreement, on the Financial Closing Effective Date:

(a) the Army, as ground lessor, and the Partnership, as ground lessee, shall enter into Supplement No. One, the amended and restated Ground Lease with respect to the Land;

(b) the Army, as ground lessor, and the Partnership, as ground lessee, shall enter into the Memorandum of Amended and Restated Ground Lease with respect to, Supplement No. One, amended and restated Ground Lease, which memorandum shall be properly executed and in proper form for recording in the real estate records of Bell and Coryell Counties, Texas; and

(c) the Partnership shall cause the Title Company to record the Memorandum of Amended and Restated Ground Lease in the real estate records of Bell and Coryell Counties, Texas recorder's office.

Section 3.6Sublease. Subject to the terms and conditions of this Agreement, on the Financial Closing Effective Date:

(a) the Partnership, as sublessor and Owner Trustee, as sublessee, shall execute and deliver the Sublease for the Land, the Residential Unit Improvements and the Personal Property.

(b) the Partnership, as sublessor and Owner Trustee, as sublessee, shall execute and deliver the Memorandum of Sublease which memorandum shall be properly executed and acknowledged and in proper form for recording in the real estate records of Bell and Coryell Counties, Texas.

(c) Owner Trustee shall prepay the rent due under the Sublease in an amount equal to REDACTED ($REDACTED), a portion of which shall be financed through the proceeds of the Tranche B Loan.

Section 3.7Bondable Lease. Subject to the terms and conditions of this Agreement, on the Financial Closing Effective Date:

(a) Owner Trustee, as lessor, and the Partnership, as lessee, shall execute and deliver the Bondable Lease with respect to the Land, Residential Unit Improvements and Personal Property.

(b) Owner Trustee, as lessor, and the Partnership, as lessee, shall execute and deliver the Memorandum of Bondable Lease, which memorandum shall be properly executed and acknowledged and in proper form for recording in the real estate records of Bell and Coryell Counties, Texas.

(c) pursuant to the Bondable Lease, Owner Trustee shall provide the Partnership the Tenant Allowance in the amount of REDACTED ($REDACTED) for tenant improvements for purposes of renovation, rehabilitation and demolition of existing Residential Unit Improvements and the construction of additional Residential Unit Improvements.

Section 3.8Amended and Restated Lock Box Agreement. Subject to the terms and conditions of this Agreement, on the Financial Closing Effective Date:

(a) the Partnership, the General Partner, the Army, Owner Trustee and the Indenture Trustee shall execute and deliver the amended and restated Lock Box Agreement.

(b) the Partnership shall cause the Tenant Allowance and the cash capital contribution from the Army, net of (i) closing costs, (ii) costs incurred by the D&C Contractor as of the date hereof (including soft costs), to which an accounting reasonably acceptable to the parties hereto shall be performed and (iii) required deposits into other Subaccounts created under the Lock Box Agreement, to be deposited into the Construction Escrow Reserve Subaccount which shall be established as a subaccount of the Lock Box Account.

Section 3.9Management, Operational and Other Agreements. Subject to the terms and conditions of this Agreement, on the Financial Closing Effective Date:

(a) the Partnership and the Army shall execute and deliver the amended and restated Business Agreement.

(b) the Partnership and ALL shall execute and deliver the D&C Contract.

(c) the Partnership, the Army, Owner Trustee, Indenture Trustee and REDACTED shall execute and deliver the Construction Consultant Agreement.

(d) ALL shall cause LLC to execute and deliver the Construction Guaranty for the benefit of the Partnership and the Construction Guaranty shall be assigned by various assignments to the Army, Owner Trustee and the Indenture Trustee (except that the obligation of LLC to guaranty the payment of Tax Basis Liquidated Damages shall be assigned only to the Owner Trustee).

(e) ALL shall execute and deliver the ALL Guaranty for the benefit of the Partnership and the ALL Guaranty shall be assigned by various assignments to the Army, Owner Trustee and the Indenture Trustee.

(f) ALL shall cause REDACTED to, and the Partnership shall, execute and deliver the Financial Advisory Services Agreement.

(g) REDACTED, in its individual capacity, and Cash Management Agent shall execute and deliver the Investment Agreement.

Section 3.10 Closing. All documents and instruments required to be delivered on the Financial Closing Effective Date pursuant to this Agreement shall be delivered at the offices of REDACTED.

### ARTICLE IX

### Expansion of Project

Section 9.1Offer to Partnership. The Army shall, to the greatest extent permitted by Applicable Law, offer the Partnership the opportunity to assume operation of the housing units and other portions of the Installation presently operated under the REDACTEDLease (such portions of the Installation being commonly known as REDACTED) upon the expiration or earlier termination of the REDACTED Lease. In addition, to the greatest extent permitted by Applicable Law, the Army shall offer the Partnership the opportunity to develop, own (at the Army's option, in fee or leasehold estates), construct, renovate, replace, rehabilitate, operate, maintain and/or finance any and all portions of the Installation which the Army desires to designate for the development and operation of housing units and which are not then included within the Property. The Army shall provide the Partnership with information relating to the property which is the subject of the offer as the Partnership may reasonably request, to the extent such information is in the possession of or is readily obtainable at no (or de minimis) expense to the Army. The Army shall not offer any other Person the right to assume operation of REDACTED or to develop, own (in fee or leasehold estate), construct, renovate, replace, rehabilitate, operate, maintain and finance any other portions of the Installation in accordance with this Section 9.1 for a period of 120 days after the effective notice provided by the Army to the Partnership under this Section 9.1 or such earlier date as the Partnership has declined, in writing, an interest in the offered property. Offers made to the Partnership pursuant to this Section 9.1 may, at the option of the Partnership, be effectuated by the Partners and/or their respective Affiliates as contemplated under Section 2.07 of the Partnership Agreement.

Section 9.2Right of Bondable Lease Landlord and Tranche A Bond Holders to Participate. If the Partnership receives an offer from the Army to make additional housing units and/or land for the construction of additional housing units available to the Partnership and the Partnership is inclined to accept such offer, the Partnership shall notify the Bondable Lease Landlord, the Indenture Trustee and the Tranche A Bond Holder Representative that such an offer has been made by the Army. The Partnership shall provide the Bondable Lease Landlord and the Tranche A Bond Holder Representative (on behalf of the Tranche A Bond Holders) with information relating to the property which is the subject of the offer as the Bondable Lease Landlord and/or the Tranche A Bond Holder Representative (on behalf of the Tranche A Bond Holders) may reasonably request, to the extent such information is in the possession of or is readily obtainable at no (or de minimis) expense to the Partnership. Each of the Bondable Lease Landlord and the Tranche A Bond Holder Representative (on behalf of the Tranche A Bond Holders) shall have the right to negotiate with the Army and the Partnership the terms upon which the Bondable Lease Landlord and/or the Tranche A Bond Holders may participate as debt and/or equity providers in the proposed development, ownership, construction, renovation, replacement, rehabilitation, operation, maintenance and/or financing of the additional housing units and related property, which may include amending the Operative Documents to incorporate the additional property into the Overall Transaction or the formation of a joint venture entity separate and apart from the Partnership as contemplated by Section 2.07 of the Partnership Agreement. Neither the Army nor the Partnership shall offer any other Person the right to participate as debt and/or equity providers in the proposed development, ownership, construction, renovation, replacement, rehabilitation, operation, maintenance and/or financing of the additional housing units and related property for a period of thirty (30) days after (x) the later of (i) the effective date of the notice provided to the Bondable Lease Landlord, the Indenture Trustee and the Tranche A Bond Holder Representative pursuant to this Section 9.2 or (ii) receipt of all information reasonably requested by the Bondable Lease Landlord or the Tranche A Bond Holder Representative during such thirty (30) day period, or (y) such earlier date as each of the Bondable Lease Landlord and the Tranche A Bond Holder Representative have declined, in writing, an interest in participating as debt and/or equity providers in the proposed transaction.

Section 9.3Competing Installation Projects. If any of the Army, the Partnership, the Private Sector Partners or any of their respective Affiliates owns a Competing Installation Project, or owns a direct or indirect interest in a Competing Installation Project, the foregoing Persons that own, or own an interest in, such Competing Installation Project shall (or, if applicable, shall cause the entity which owns such Competing Installation Project to) enter into a written agreement with the Partnership, Subtenant and any Party-In-Possession pursuant to which such Persons shall agree that military personnel and other prospective Residents shall be assigned quarters at the Installation in a manner which does not discriminate between the Competing Installation Project and the Property and in accordance with procedures to be agreed upon at the time, but which will include as one relevant criterion the proximity of the quarters to personnel's assigned duty station. The execution of the written agreement contemplated by the immediately preceding sentence shall require the prior written consent of each of the Owner Trustee, the Indenture Trustee and the Tranche A Bond Holder Representative, which consent shall not be unreasonably withheld, delayed or conditioned.

Section 9.4Competing Projects. If the Army owns a Competing Project, or owns a direct or indirect interest in a Competing Project, the Army shall (or, if applicable, shall cause the entity which owns such Competing Project to) enter into a written agreement with the Partnership, Subtenant and any Party-In-Possession pursuant to which such parties shall agree that military personnel and other prospective residents of the Competing Project and the Property shall be assigned quarters among the competing projects in a manner which does not discriminate between the Competing Project and the Property in accordance with procedures to be agreed upon at the time, but which will include as one relevant criterion the proximity of the quarters to personnel's assigned duty station. The execution of the written agreement contemplated by the immediately preceding sentence shall require the prior written consent of each of the Owner Trustee, the Indenture Trustee and the Tranche A Bond Holder Representative, which consent shall not be unreasonably withheld, delayed or conditioned.

### PARTNERSHIP AGREEMENT

THIS SECOND AMENDED AND RESTATED AND MEMORIALIZED AGREEMENT OF LIMITED PARTNERSHIP OF REDACTED LP (this “Agreement”) dated as of Nov. 1, 2001 to be effective as of Oct. 1, 2001 (the “Effective Date”), by and among REDACTED INC., formerly known as REDACTED, a Texas corporation, as general partner (“General Partner”), REDACTED, a Delaware limited liability company, as a limited partner (“REDACTED-BM”), REDACTED LLC, a Delaware limited liability company, as a limited partner (“REDACTED”) and THE UNITED STATES OF AMERICA, by THE SECRETARY OF THE ARMY, as a limited partner (the “Army”) (REDACTED, REDACTED and the Army are sometimes collectively referred to as the “Limited Partners”).

WHEREAS, on Aug. 6, 1999, the Army issued the RFQ and in response to the RFQ, ALL and TCR jointly submitted the SOQ;

WHEREAS, during the period the Army was evaluating the submittals received in response to the RFQ, General Partner (as general partner), ALL and TCR (each as limited partners) formed the Partnership by causing to be filed the Partnership Certificate;

WHEREAS, the Partnership has succeeded to all of the respective rights of ALL and TCR under the SOQ;

WHEREAS, REDACTED has succeeded to all of the rights of ALL in and to the Partnership as a limited partner;

WHEREAS, REDACTED has succeeded to all of the rights of TCR in and to the Partnership as a limited partner;

WHEREAS, pursuant to that certain Solicitation/Contract/Order for Commercial Terms, dated Jun. 28, 2000, the Army granted the Partnership the Award to prepare the CDMP for the Installation;

WHEREAS, pursuant to that certain Amendment of Solicitation/Modification of Contract, dated Jun. 8, 2001, Congress granted its approval of the CDMP and the Army authorized the Partnership to proceed to consummate the transactions contemplated by the CDMP by issuing the Notice to Proceed;

WHEREAS, General Partner, REDACTED and REDACTED memorialized and amended the Partnership's (previously unwritten) partnership agreement pursuant to that certain Amended and Memorialized Agreement of Limited Partnership of REDACTED LP, dated as of Oct. 1, 2001 (the “Original Agreement”), which Original Agreement, among other things, admitted the Army as a limited partner, all upon the terms and conditions of the Original Agreement;

WHEREAS, the Army acquired a limited partnership interest in, and has been admitted as a limited partner in, the Partnership;

WHEREAS, the Land, the Improvements and the Personal Property were contributed by the Army to the Partnership as provided in the Original Agreement; and

WHEREAS, in order to effectuate the privatization of the housing facilities at the Installation pursuant to the RFQ, the SOQ, the CDMP and the Notice to Proceed and in accordance with the RCI Program and the MHPI Act, the Partners desire to, in connection with the Financial Closing, continue the Partnership and to amend and restate the Original Agreement on the terms and conditions hereinafter set forth in order to own, maintain, improve, lease and otherwise operate the Property in accordance with the Operative Documents.

NOW, THEREFORE, the Partners hereby agree that the Original Agreement is amended and restated in its entirety as follows:

### ARTICLE II

### General Provisions

Section 2.1Continuation of the Partnership. The Partners do hereby continue the Partnership under and pursuant to the Partnership Law and this Agreement. The Partnership Interests of the Partners as of the Effective Date are identified on Exhibit A attached hereto and made a part hereof.

Section 2.2Name. The name of the Partnership is REDACTED LP and such name shall be used for no purpose other than as set forth in Section 2.03. General Partner shall cause to be filed on behalf of the Partnership such limited partnership or assumed or fictitious name certificate or certificates as may from time to time be required by law.

Section 2.3Business. The business of the Partnership shall be (a) to acquire, own, hold, manage, finance, operate, lease, improve, alter and dispose of the Property in accordance with the terms of the Operative Documents, (b) to acquire, own, hold, manage, finance, operate, lease, improve, alter and dispose of additional property at the Installation in accordance with the terms of the Operative Documents, including Section 9.1 of the Business Agreement, which additional property shall be deemed to constitute a portion of the Property upon its acquisition and (c) to carry on any other lawful activity which may be incidental to the foregoing. The Partnership shall be a limited partnership only for the purposes specified in this Section 2.03 and shall not be deemed to create a joint venture, partnership or any other relationship between the Partners with respect to any activities whatsoever other than the activities within the business purposes of the Partnership set forth in this Section 2.03. No Partner shall have any power to bind any other Partner except as specifically provided in this Agreement.

Section 2.4Office. The principal office of the Partnership shall be REDACTED, or such other location as the General Partner may select from time to time.

Section 2.5Term. The term of the Partnership shall commence upon filing the Partnership Certificate and shall continue until 11:59 p.m., Dec. 31, 2080, unless dissolved and terminated at an earlier date in the manner provided in Article XI.

Section 2.6Ownership of Partnership Property. All property acquired by the Partnership, real, personal, or mixed, tangible or intangible, shall be owned by the Partnership as an entity, and no Partner, individually, shall have any ownership interest therein (it being understood that the Army's separate property interests (i) as ground lessor under the Ground Lease and (ii) expressly reserved under the Deed, are not affected by or violative of this provision). Each Partner hereby expressly waives the right to require partition of any Partnership property or any part thereof. No Partner nor the Partnership shall be responsible nor liable for any indebtedness or obligation of any other Partner incurred whether before or after execution of this Agreement, except as to their Partnership responsibilities, liabilities, indebtedness or obligations incurred pursuant to and as limited by the terms of this Agreement.

Section 2.7Related Entities. From time to time, the Partners may form such other corporations, general partnerships, limited partnerships, limited liability companies or other entities to acquire, own, hold, manage, finance, operate, lease, improve, alter and dispose of property at the Installation (other than the Property) as contemplated by Section 9.1 of the Participation Agreement. The organizational documents of any such entity shall contain provisions substantially similar to the provisions of this Agreement, except as necessary to reflect (i) the particular property to be acquired by such entity, (ii) the requirements of any third party investors or lenders as to the single purpose and/or bankruptcy remoteness of such entity, (iii) the particular legal form of such entity, (iv) as necessary to ensure the same treatment of the Partners and their respective direct or indirect interests in the entity as would have been the case if the property to be owned by such entity were owned by the Partnership pursuant to this Agreement and (v) as the Partners may otherwise agree. In any event, any such entity shall be organized so as to preserve the limited liability of the Limited Partners with respect to such entity.

### ARTICLE III

### Capital Contributions

Section 3.1Initial Capital Contributions.

(a) General Partner. As of the Effective Date, General Partner has contributed the amount of REDACTED ($REDACTED) of capital to the Partnership.

(b) REDACTED-BM. As of the Effective Date, REDACTED-BM has contributed the amount of REDACTED ($REDACTED) of capital to the Partnership.

(c) REDACTED As of the Effective Date, REDACTED has contributed the amount of REDACTED ($REDACTED) of capital to the Partnership.

(d) The Army. Simultaneously with the execution of this Agreement, the Army has contributed to the Partnership (i) a leasehold interest in the Land pursuant to the Ground Lease, (ii) fee simple title with a right of reversion in and to the Improvements pursuant to the Deed, and (iii) the Personal Property pursuant to the Bill of Sale. The Partners have agreed that for purposes of determining the amount of the Army's Initial Capital Contributions, the contributed property has a Book Value of REDACTED ($REDACTED).

Section 3.2Return of Capital Contributions. No Partner will have the right to return of its Capital Contribution except in accordance with Article V or Article XI.

Section 3.3Additional Capital Contributions.

(a) General Partner may make Additional Capital Contributions to the Partnership in amounts equal to any liability incurred by General Partner as a result of, or by virtue of, its constituting a general partner of the Partnership.

(c) The Partners may make Additional Capital Contributions to the Partnership, at the time, and in amounts equal to the costs of improvements to be made to the Property from the proceeds of such Additional Capital Contributions (as such improvements and Additional Capital Contributions may be expressly authorized by the Partners as a Major Decision). All Additional Capital Contributions made pursuant to this Section 3.03(c) shall be deposited in the Lock Box Account (in such subaccounts as the Partners may designate at the time).

(d) The Army shall, on the Financial Closing Date, make an Additional Capital Contribution in the amount of REDACTED ($REDACTED). The Additional Capital Contribution made pursuant to this Section 3.03(d) shall be paid directly to the Cash Management Agent pursuant to Section 3.2(b) of the Lock Box Agreement for application under Section 3.2(d) of the Lock Box Agreement.

(e) Except as otherwise provided in Section 3.03(a), (b), (c) and (d), no Partner shall be permitted to make any Additional Capital Contribution to the Partnership without the express written consent of each other Partner. If any Additional Capital Contributions are to be made by a Partner pursuant to this Section 3.03(e), the Partners may at such time consider any amendments to this Agreement which may be appropriate to reflect the making of such Additional Capital Contributions by one or more of the Partners.

(f) Except as otherwise provided in Section 3.03(b) and (d), no Limited Partner shall be required to make any Additional Capital Contributions to the Partnership.

(g) The General Partner shall timely enforce the requirement of the Limited Partners to make the Additional Capital Contributions under this Section 3.03.

### ARTICLE IV

### Capital Accounts

Section 4.1Capital Accounts. The Partnership shall maintain a separate Capital Account for each Partner in accordance with federal income tax accounting principles and Treasury Regulation section 1.704-1(b), which account shall, as of any given date, reflect such Partner's Capital Contribution, (i) increased to reflect its distributive share of Partnership, Net Income and gain (or item thereof), or (ii) decreased to reflect its distributive share of Partnership Net Loss and deduction (or item thereof), for each fiscal year or fraction thereof, and the amount of cash or the net Book Value of property distributed by the Partnership to such Partner.

The Capital Accounts of each Partner as of the Financial Closing Effective Date, after giving effect to the Army's Additional Capital Contribution under Section 3.03(d) of this Agreement are as follows:

| | |
|---|---|
| General Partner: | $REDACTED |
| REDACTED: | $REDACTED |
| REDACTED: | $REDACTED |
| Army: | $REDACTED |

The following additional rules shall apply in maintaining Capital Accounts:

(a) If the Book Values of Partnership assets are adjusted, as provided in the definition of Book Value, the Capital Accounts of all Partners shall be adjusted simultaneously to reflect the aggregate net adjustment as if the Partnership recognized gain or loss equal to the amount of such aggregate net adjustment and such gain or loss were allocated to the Partners in the manner required by Article VI.

(b) If, in any taxable year, the Partnership has in effect an election under section 754 of the Code, Capital Accounts shall be adjusted in accordance with Treasury Regulation section 1.704-1(b)(2)(iv)(m).

(c) The foregoing provisions and the other provisions of this Agreement relating to the maintenance of Capital Accounts are intended to comply with Treasury Regulation section 1.704-1(b), and shall be interpreted and applied in a manner consistent with such Treasury Regulations. To the extent such provisions are inconsistent with such regulations or are incomplete with respect thereto, the Capital Accounts of the Partners shall be maintained in accordance with such Treasury Regulations.

(d) Except as may otherwise be provided in this Agreement, whenever it is necessary to determine the Capital Account of a Partner, the Capital Account of such Partner shall be determined after giving effect to all allocations and distributions for transactions effected prior to the time as of which such determination is to be made. Any Partner who shall acquire an interest in the Partnership or whose interest shall be increased by means of a transfer to such Partner of all or part of another Partner's interest in the Partnership, shall have a Capital Account which reflects such transfer. Any Partner who transfers a part of its interest in the Partnership shall have a Capital Account which reflects such transfer.

### ARTICLE V

### Allocations and Distributions of Available Cash and Distributions of Net Proceeds of Capital Events

Section 5.1Allocations and Distributions of Available Cash.

(a) The Partnership shall apply Available Cash in accordance with the cash waterfall provisions of Section 4.1 of the Lock Box Agreement.

(b) Subject to Section 5.03, funds in the Partner Distribution Reserve Subaccount shall be distributed each month in the following order of priority:

First, to the Private Sector Partners until such time as each Private Sector Partner has received distributions under this priority First of this Section 5.01(b) equal to such Private Sector Partner's Accrued Preferred Return;

Second, to the Private Sector Partners until such time as each Private Sector Partner has received distributions under this priority Second of this Section 5.01(b) equal to such Private Sector Partner's Preferred Return for the then current month;

Third, to the Private Sector Partners until such time as each Private Sector Partner has received distributions under this priority Third of this Section 5.01(b) equal to such Private Sector Partner's Accrued Upside Equity Return (with each Private Sector Partner's distribution under this priority Third of this Section 5.01(b) being allocated to Accrued Upside Equity Returns in the chronological order in which such Accrued Upside Equity Returns were accrued);

Fourth, to the Private Sector Partners until such time as each Private Sector Partner has received distributions under this priority Fourth of this Section 5.01(b) equal to such Private Sector Partner's Upside Equity Return for the then current month; and

Fifth, if a Base Closure Announcement has been made and General Partner elects, in its sole and absolute discretion, to make further distributions to the Private Sector Partners, the balance (or portion thereof as the General Partner shall have determined to distribute) shall be distributed among the Private Sector Partners in accordance with the following percentages:

| | |
|---|---|
| General Partner | 2% |
| REDACTED | 73% |
| REDACTED | 25% |

To the extent that more than one such Private Sector Partner shall be entitled to receive a distribution described in any of priorities First, Second, Third or Fourth of this Section 5.01(b), such distribution shall be made to each such Private Sector Partner on a pro rata basis based upon the amount of distribution which each Private Sector Partner would need to receive the maximum Accrued Preferred Return, Preferred Return, Accrued Upside Equity Return or Upside Equity Return, as the case may be, permitted under the relevant priority.

Section 5.2Distributions Upon a Capital Event. Following a Capital Event, but subject to Section 5.03, all funds in the Partner Distribution Reserve Subaccount and all Net Proceeds of a Capital Event shall be distributed to the Partners in the following order of priority:

First, to the Private Sector Partners until such time as each Private Sector Partner has received distributions under this priority First of this Section 5.02 equal to such Private Sector Partner's Accrued Preferred Return;

Second, to the Private Sector Partners until such time as each Private Sector Partner has received distributions under this priority Second of this Section 5.02 equal to such Private Sector Partner's Preferred Return for the then current month;

Third, to the Private Sector Partners until such time as each Private Sector Partner has received distributions under this priority Third of this Section 5.02 equal to such Private Sector Partner's Accrued Upside Equity Return (with each Private Sector Partner's distribution under this priority Third of this Section 5.02 being allocated to Accrued Upside Equity Returns in the chronological order in which such Accrued Upside Equity Returns were accrued);

Fourth, to the Private Sector Partners until such time as each Private Sector Partner has received distributions under this priority Fourth of this Section 5.02 equal to such Private Sector Partner's Upside Equity Return for the then current month;

Fifth, to the Private Sector Partners, until such time as each Private Sector Partner has recovered under this priority Fifth of this Section 5.02 its respective Unrecovered Capital;

Sixth, to the Army, until such time as the Army has recovered under this priority Sixth of this Section 5.02 its Unrecovered Capital; and

Seventh, the balance shall be distributed among the Partners in accordance with the following percentages:

| | |
|---|---|
| General Partner | 1.0% |
| REDACTED | 36.5% |
| REDACTED | 12.5% |
| Army | 50.0% |

To the extent that more than one such Private Sector Partner shall be entitled to receive a distribution described in any of priorities First, Second, Third, Fourth or Fifth of this Section 5.02, such distribution shall be made to each such Private Sector Partner on a pro rata basis based upon the amount of distribution which each Private Sector Partner would need to receive the maximum Accrued Preferred Return, Preferred Return, Accrued Upside Equity Return, Upside Equity Return or Unrecovered Capital, as the case may be, permitted under the relevant priority.

Section 5.3Effect of Bondable Lease Event of Default or Cash Trap. In no event shall any distribution or return of Available Cash or Unrecovered Capital be made to any Partner pursuant to this Article V or Section 11.02 to the extent that a Bondable Lease Event of Default is continuing or such monies are being trapped in accordance with the provisions of the Lock Box Agreement.

### ARTICLE VI

### Allocations

Section 6.1Allocation of Net Income and Net Loss.

(a) Net Income from Operations. Net Income from operation of the Property for each fiscal year or portion thereof shall be allocated among the Partners as follows:

(1) First, to the Army until the balances in the Capital Accounts of the Private Sector Partners have been reduced to zero;

(2) Second, to the Private Sector Partners, in an amount equal to the amount of Available Cash distributed to such Private Sector Partners for such fiscal year under Section 5.01 in excess of the then-current Capital Account balances of the Private Sector Partners (before taking into account the allocation made pursuant to this Section 6.01(a)(ii)), provided, that if the Net Income of the Partnership is not sufficient to equal the Available Cash distributed to the Private Sector Partners for such fiscal year, gross income of the Partnership will be allocated to each Private Sector Partner in an amount sufficient to equal the Available Cash distributed to such Private Sector Partners for such fiscal year under Section 5.01; and

(3) Any remaining Net Income shall be allocated to the Army.

(b) Net Income from Sale or Disposition of the Property. Net Income from sale or other disposition of the Property shall be allocated among the Partners as follows:

(1) First, to the Private Sector Partners, in amounts sufficient to cause the balances in their Capital Accounts to equal the amounts to be distributed to the Private Sector Partners under Section 5.02 as a result of such sale. In the event that there is insufficient Net Income from a sale or other disposition of the Property to cause the balances in the Private Sector Partners' Capital Accounts to equal the amounts to be distributed to the Private Sector Partners under Section 5.02 as a result of such sale or other disposition, then any provision of this Agreement to the contrary notwithstanding, items of gross income from operation of the Property for the fiscal year that includes the date of such sale or other disposition will be allocated to the Private Sector Partners to the extent necessary in order that the balances in the Private Sector Partners' Capital Accounts equal the amounts to be distributed to the Private Sector Partners under Section 5.02; and to the extent such items of gross income for such fiscal year are insufficient, items of gross income from operation of the Property for the preceding fiscal year and the next preceding year, and so forth, for all Partnership taxable years for which an amended return can be timely filed, will be allocated to the Private Sector Partners to the extent necessary to cause the balances in the Private Sector Partners' Capital Accounts to equal the amount of distributions hereunder.

(2) Any remaining Net Income will be allocated to the Army.

(c) Net Loss. Net Loss for each fiscal year shall be allocated among the Partners as follows:

(1) First, to any Private Sector Partners with positive balances in their Capital Accounts, in proportion to the balances in such Capital Accounts, until such Capital Accounts have been reduced to zero.

(2) The balance, if any, to the Army.

(d) Deficit Capital Account and Nonrecourse Debt Rules. Notwithstanding the general allocation rules set forth above, the following special allocation rules shall apply under the circumstances described therein.

(1) Limitation on Loss Allocations. The Net Losses allocated to any Partner pursuant to Section 6.01(c) with respect to any fiscal year shall not exceed the maximum amount of Net Losses that can be so allocated without causing such Partner to have an Adjusted Capital Account Deficit at the end of such fiscal year. All Net Losses in excess of the limitation set forth in this Section 6.01(d)(i) shall be allocated to the Partners not subject to the foregoing limitation and then to the General Partner.

(2) Qualified Income Offset. If in any fiscal year a Partner unexpectedly receives an adjustment, allocation or distribution described in Treasury Regulation section 1.704-1(b)(2)(ii)(d)(4), (5) or (6), and such adjustment, allocation or distribution causes or increases an Adjusted Capital Account Deficit for such Partner, then, before any other allocations are made under this Agreement or otherwise, such Partner shall be allocated items of income and gain (consisting of a pro rata portion of each item of Partnership income, including gross income and gain) in an amount and manner sufficient to eliminate such Adjusted Capital Account Deficit as quickly as possible.

(3) Partnership Minimum Gain Chargeback. If there is a net decrease in Partnership Minimum Gain during any fiscal year, each Partner shall be allocated items of income and gain for such fiscal year (and, if necessary, for subsequent fiscal years) in proportion to, and to the extent of, an amount equal to such Partner's share of the net decrease in Partnership Minimum Gain, in accordance with Treasury Regulation section 1.704-2(f) and (g).

(4) Partner Nonrecourse Debt Minimum Gain Chargeback. If there is a net decrease in Partner Nonrecourse Debt Minimum Gain attributable to a Partner Nonrecourse Debt during any fiscal year, each Partner who has a share of the Partner Nonrecourse Debt Minimum Gain attributable to such Partner Nonrecourse Debt, determined in accordance with Treasury Regulation section 1.704-2(i), shall be specially allocated items of income and gain for such fiscal year (and, if necessary, subsequent fiscal years) in an amount equal to such Partner's share of the net decrease in Partner Nonrecourse Debt Minimum Gain attributable to such Partner Nonrecourse Debt, determined in accordance with Treasury Regulation section 1.704-2(i).

(5) Partnership Nonrecourse Deductions. Partnership Nonrecourse Deductions for any fiscal year shall be specially allocated in the same manner as Net Loss.

(6) Partner Nonrecourse Deductions. Any Partner Nonrecourse Deduction for any fiscal year shall be specially allocated to the Partner who bears the economic risk of loss with respect to the Partner Nonrecourse Debt to which such Partner Nonrecourse Deductions are attributable in accordance with Treasury Regulation section 1.704-2(i).

(e) Tax Allocations.

(1) Generally. Except as set forth in Section 6.01(e)(ii), allocations for tax purposes of items of income, gain, loss, deduction and credit shall be made in the same manner as allocations for book purposes.

(2) Special Rules. In accordance with Code section 704(c) and the Treasury Regulations thereunder, income, gain, loss and deduction with respect to any property contributed (or distributed with respect to property so contributed) to the capital of the Partnership shall, solely for tax purposes, be allocated among the Partners so as to take account of any variation between the adjusted basis of such property to the Partnership for federal income tax purposes and its initial Book Value.

In the event the Book Value of Partnership property is adjusted pursuant to the definition of Book Value, subsequent allocations of income, gain, loss, and deduction with respect to the Property shall take account of any variation between the adjusted basis of such asset for federal income tax purposes and the Book Value in the same manner as under Code section 704(c) and the Treasury Regulations thereunder.

The General Partner shall make such allocations in accordance with Treasury Regulation section 1.704-3 using the method selected by the General Partner.

(3) Allocations pursuant to this Section 6.01(e) are solely for purposes of federal, state, and local taxes and shall not affect, or in any way be taken into account in computing, any Partner's Capital Account or share of Net Income, Net Loss, other items, or distributions pursuant to any other provision of this Agreement.

### ARTICLE XIV

### Single Purpose Entity

Section 14.1 Purpose. The Partnership's business and purpose shall consist solely of the matters set forth in Section 2.03.

Section 14.2 Powers and Duties.

(a) Notwithstanding any other provisions of this Agreement and so long as any obligations secured by the Indenture remain outstanding and not discharged in full and/or so long as the Sublease is in effect, without the prior written consent of the Indenture Trustee and the Owner Trustee, General Partner and the Partnership shall have no authority to:

(i) borrow money or incur indebtedness on behalf of the Partnership other than normal trade accounts payable and lease obligations in the normal course of business, or grant consensual liens on the Partnership's property; except, however, that General Partner is hereby authorized to secure financing for the Partnership which is expressly permitted under the terms of the Indenture and other indebtedness expressly permitted therein or in the documents related to the Indenture;

(ii) dissolve or liquidate the Partnership;

(iii) sell or lease, or otherwise voluntarily dispose of all or substantially all of the assets of the Partnership;

(iv) merge or consolidate with any other entity; or

(v) enter into any contracts or agreements with Partners or Affiliates thereof, unless the other contracting party covenants that it shall not, so long as the Bondable Lease, the Sublease and/or any obligation secured by the Indenture remains in effect or outstanding and not discharged in full, (A) file, consent to, or join in any pleading, petition, motion, answer or other action which seeks to have entered against the Partnership a voluntary or involuntary order for relief (or any similar remedy) under any federal, state or foreign law, now or hereafter in effect, relating to insolvency, bankruptcy, rehabilitation, liquidation or reorganization of the Partnership, (B) convene a meeting of the creditors of the Partnership of any class thereof, (C) propose the adjudication of the Partnership as a bankrupt or its reorganization pursuant to Title 11 of the United States code or any similar federal, state, or foreign law now or hereafter in effect, or (D) seek to have a receiver, trustee or liquidator (or other similar official) appointed for, or take possession or charge of, the Partnership or of all or substantially all of its assets or business.

(b) Notwithstanding the foregoing and so long as the Bondable Lease, the Sublease and/or any obligation secured by the Indenture remains in effect or outstanding and not discharged in full, General Partner and the Partnership shall have no authority, unless such action has been approved by the unanimous vote of General Partner's Board of Directors and the unanimous consent of all other Partners, to file a voluntary petition or otherwise initiate proceedings to have the Partnership adjudicated bankrupt or insolvent, or consent to the institution of bankruptcy or insolvency proceedings against the Partnership, or file a petition seeking or consenting to reorganization or relief of the Partnership as debtor under any applicable federal or state law relating to bankruptcy, insolvency, or other relief for debtors with respect to the Partnership; or seek or consent to the appointment of any trustee, receiver, conservator, assignee, sequestrator, custodian, liquidator (or other similar official) of the Partnership or of all or any substantial part of the properties and assets of the Partnership, or make any general assignment for the benefit of creditors of the Partnership, or admit in writing the inability of the Partnership to pay its debts generally as they become due or declare or effect a moratorium on the Partnership debt or take any action in furtherance of any such action. Within thirty (30) days after the written request of the Indenture Trustee or the Tranche A Bond Holder Representative, the General Partner shall appoint an independent director to its board of directors.

(c) So long as the Bondable Lease, the Sublease and/or any obligation secured by the Indenture remains in effect or outstanding and not discharged in full, the Partnership shall have a corporate general partner having articles of incorporation containing the restrictions and terms set forth in this Article XIV.

Section 14.3 Title to Partnership Property. All property owned by the Partnership shall be owned by the Partnership as an entity and, insofar as permitted by applicable law, no Partner shall have any ownership interest in any Partnership property in its individual name or right or capacity, and each Partner's partnership interest shall be personal property for all purposes.

Section 14.4 Separateness and Operations. The Partnership shall:

(1) maintain books, records and bank accounts separate from those of any other Person;

(2) maintain its assets in such a manner that it is not costly or difficult to segregate, identify or ascertain such assets;

(3) hold regular meetings, as appropriate, to conduct the business of the Partnership, and observe all customary organizational and operational formalities;

(4) hold itself out to creditors and the public as a legal entity separate and distinct from any other entity;

(5) prepare separate tax returns and financial statements, or if part of a consolidated group, then it will be shown as a separate number of such group;

(6) pay the salaries of its own separate employees from its own funds and allocate and charge fairly and reasonably any common employee or overheard shared with Affiliates;

(7) transact all business with Affiliates on an arm's-length basis and pursuant to enforceable agreements;

(8) conduct business in its own name, and use separate stationery, invoices and checks bearing its own name;

(9) pay its own liabilities and expenses out of its own funds;

(10) not commingle its assets or funds with those of any other Person and shall hold all of its assets in its own name;

(11) not assume, guarantee or pay the debts or obligations of any other Person nor pledge its assets for the benefit of any other Person;

(12) correct any known misunderstanding as to its separate identity;

(13) not permit any Affiliate to guarantee or pay its obligations; and

(14) except with respect to the Tranche B Loan, not make loans or advances to any other Person.

Section 14.5 Effect of Bankruptcy and Other Matters. The bankruptcy, death, dissolution, liquidation, termination or adjudication of incompetency of a Partner shall not cause the termination or dissolution of the Partnership and the business of the Partnership shall continue (unless such event results in a situation in which termination or dissolution is otherwise required hereunder). Upon any such occurrence, the trustee, receiver, executor, administrator, committee, guardian or conservator of such Partner shall have all the rights of such Partner for the purpose of settling or managing its estate or property, subject to satisfying conditions precedent to the admission of such assignee or a substitute Partner. The foregoing shall apply to the extent permitted by applicable law.

### GROUND LEASE

THIS AMENDED AND RESTATED GROUND LEASE (this “Ground Lease”), dated as of Nov. 1, 2001, to be effective as of Oct. 1, 2001 (the “Effective Date”), by and between THE UNITED STATES OF AMERICA, by THE SECRETARY OF THE ARMY (the “Army”) and REDACTED LP, a Texas limited partnership (the “Lessee”).

WITNESSETH:

That the Army, by the authority of Title 10, United States Code, Section 2878, and for the consideration hereinafter set forth, hereby leases to the Lessee the Land identified in Exhibit A attached hereto and made a part hereof, specifically excluding from the demise under this Ground Lease any and all Improvements, which Land may be used for the design, finance, construction, reconstruction, operation, maintenance, renovation, replacement, rehabilitation and development of Housing Units and related ancillary facilities primarily for use by military personnel and their families at the Installation.

Pursuant to the Deed, the Army granted to the Lessee fee simple title with a right of reversion in and to all Improvements. Pursuant to the Bill of Sale, the Army transferred to the Lessee all of the Army's right, title and interest in and to the Personal Property.

This Ground Lease, the Business Agreement and the other Ground Lease Operative Documents, inter alia, collectively describe the conveyance of the Property and agreements between the Army and the Lessee with respect to the design, finance, construction, reconstruction, operation, maintenance, renovation, replacement, rehabilitation and development of Housing Units and related ancillary facilities primarily for use by military personnel and their families at the Installation. The Municipal Services Agreement sets forth the respective obligations of the Army and the Lessee with respect to the provision of Utilities, Infrastructure and other Municipal Services. All income of the Lessee shall be deposited into the Lock Box Account and disbursed in accordance with the Lock Box Agreement.

This Supplement No. One is executed pursuant to Section 31. Modifications and amends and restates the Ground Lease effective Oct. 1, 2001, to clarify Sections 9. Transfer and Assignments, 23. Environmental Provisions and 34. Additional Covenants and Conditions; Other Ground Lease Operative Documents and to make other minor revisions in connection with the Financial Closing.

THIS GROUND LEASE is granted subject to the following conditions:

2. Term

(a) The Land is hereby demised for an initial term of approximately fifty (50) years, commencing at 12:01 a.m. Central Time on the Effective Date and terminating at 11:59 p.m. Central Time on Aug. 31, 2052.

(b) The Army may, by written notice given to the Lessee not later than Jan. 30, 2050, extend the term of this Ground Lease and the other Ground Lease Operative Documents for one (1) additional period of twenty-five (25) years, commencing upon the expiration of the initial term set forth in Section 2(a) and terminating at 11:59 p.m. Central Time on Aug. 31, 2077. Any such extension shall be upon all of the terms, covenants and conditions of the Ground Lease Operative Documents.

3. Consideration

The consideration for the Ground Lease is (i) the grant to the Army of a fifty percent (50%) limited partnership interest in the Lessee and (ii) Lessee's agreement to operate and maintain the Property and design, finance, construct, reconstruct, operate, maintain, renovate, replace, rehabilitate and develop Housing Units and ancillary facilities primarily for use by military personnel and their families at the Installation in accordance with the terms of the Ground Lease Operative Documents.

4. Notices

All correspondence and notices required or desired to be given pursuant to this Ground Lease shall be made in accordance with the terms of Article XX of the Business Agreement.

5. Authorized Representatives

Except as otherwise specifically provided, any reference herein to “Army,” “District Engineer,” or “said officer” shall include their duly authorized representatives or successors. Unless otherwise indicated in this Ground Lease, the District Engineer (as described below) shall be designated as the primary duly authorized representative of the Army for interaction with the Lessee. The Army may at any time designate another or an additional duly authorized representative. Any reference to “Lessee” shall include any of its permitted sublessees, assignees, transferees, successors and their duly authorized representatives, except Residents of individual Housing Units.

### BUSINESS AGREEMENT

THIS AMENDED AND RESTATED BUSINESS AGREEMENT (this “Agreement”), dated as of Nov. 1, 2001, to be effective as of Oct. 1, 2001 (the “Effective Date”), by and between THE UNITED STATES OF AMERICA, by THE SECRETARY OF THE ARMY (the “Army”) and REDACTED LP, a Texas limited partnership (the “Partnership”).

Recitals:

A. Pursuant to the Ground Lease, a memorandum of which is intended to be recorded in Bell and Coryell Counties, Texas, the Army leased to the Partnership the Land, as more particularly described on Exhibit A-1 attached hereto and made a part hereof.

B. Pursuant to the Deed, which is intended to be recorded in Bell and Coryell Counties, Texas, the Army granted to the Partnership fee simple title with a right of reversion in and to the Improvements.

C. Pursuant to the Bill of Sale, the Army transferred to the Partnership all of the Army's right, title and interest in and to the Personal Property.

D. The parties entered into that certain Business Agreement, by and between the Partnership and the Army, dated as of the Effective Date, in order to undertake certain obligations with respect to the design, finance, construction, reconstruction, operation, maintenance, renovation, replacement, rehabilitation and development of the Property in connection with the transactions contemplated by the Ground Lease Operative Documents.

E. The parties desire to amend and restate the business agreement referenced in Recital D upon the terms and conditions hereof, which amendment and restatement shall be effective as of the Effective Date.

NOW, THEREFORE, for valuable consideration, the receipt and sufficiency of which are hereby acknowledged, the parties hereto hereby agree that the business agreement referenced in Recital D is amended and restated in its entirety as follows:

### ARTICLE II

### Term

Section 2.1Term. The term of this Agreement shall be co-extensive with the Ground Lease Term and shall automatically terminate upon the expiration or earlier termination of the Ground Lease.

### ARTICLE III

### Net Lease

Section 3.1Net Lease. The Ground Lease is a “net lease.” The Partnership's obligations arising or accruing during the Ground Lease Term to pay all amounts due and payable pursuant to the Ground Lease Operative Documents shall be absolute and unconditional, and the Partnership shall pay all such sums without notice, demand, counterclaim, set-off, deduction or defense, and without abatement, suspension, deferment, diminution or reduction, free from any charges, assessments, impositions, expenses or deductions of any and every kind or nature whatsoever, except as otherwise expressly provided herein and/or in any of the other Ground Lease Operative Documents.

The invention can be characterized as a method in which a series of steps are performed in combination to structure the privatization of the development, management and ownership of one or more military housing communities (MFC) included on a given parcel of real property. Such a MFC includes housing for occupancy primarily by an arbitrary number, N, of service personnel of one or more branches of the U.S. armed forces, as well as their respective families, if any.

The invention can also be characterized as a community development and management plan (CDMP) in which the CDMP is structured in response to a request for qualifications issued in connection with a military housing privatization initiative. Such initiatives call for the the development, management and ownership of one or more military housing communities (MFC) on a parcel of land that is to be privatized, with the MFC including housing for occupancy primarily by an arbitrary number, N, of service personnel of a branch of the U.S. armed forces and their respective families, if any.

What is claimed is:

1. A method for structuring the privatization of the development, management and ownership of one or more military housing communities (MFC) included on a parcel of real property, the MFC including housing for occupancy primarily by N service personnel of a branch of the U.S. armed forces, comprising the steps of:
a) forming a limited liability entity (LLE) having at least two owners including the branch of the U.S. armed forces and at least one private sector entity;
b) in a governing instrument of the LLE, allocating to each private sector entity a percentage of any income collected by the LLE which correlates directly with the actual amount of income distributed to each said private sector entity;
c) providing the LLE with a real-property interest in the parcel and any improvements thereto;
d) capitalizing the LLE with at least one of cash and an in-kind contribution from the owners;
e) collecting as income to the LLE a basic allowance for housing (BAH) for each of the N service personnel occupying the MFC; and
e) covering expenses associated with developing and managing the MFC included on the parcel using a portion of the collected income.

2. The method as in claim 1, including the additional step of distributing a second portion of the collected income to each said private sector entity so as to satisfy a prescribed rate of return.

3. The method as in claim 2, including the further steps of allocating to the branch of the U.S. armed forces a third portion of the collected income.

4. The method as in claim 3, wherein the allocation of the third portion of the collected income is defined in the governing instrument.

5. The method as in claim 3, including the additional step of allocating to the branch of the United States armed forces a share of voting rights in the LLE, the third portion of the collected income being disproportionately large compared to the share of voting rights.

6. The method as in claim 3, wherein the third portion of the collected income allocated to the branch of the U.S. armed forces is free of federal income taxation and is available for use in the development, management and operation of the applicable MFC.

7. The method as in claim 6, including the additional step of investing at least some of the income allocated to the branch of the U.S. armed forces, wherein the invested income is invested in a reserve account to earn interest free of federal taxes.

8. The method as in claim 6, wherein the governing instrument specifies income sharing, voting rights, and a tax allocation among the owners.

9. The method as in claim 6, wherein the prescribed rate of return includes at least one of a specified preferred return and a specified return.

10. The method as in claim 6, wherein the branch of the U.S. armed forces includes a owner selected from the group of the army, air force, navy, marines and coast guard.

11. The method as in claim 1, wherein the LLE is a pass-through entity for minimizing tax consequences in privatizing the applicable MFC.

12. The method as in claim 1, wherein the covering step includes spending the remainder of any collected income on the development and management of the applicable MFC.

13. The method as in claim 1, wherein the governing instrument of the LLE (a) allocates a majority of the collected income to the branch of the U.S. armed forces, (b) specifies that income allocated to the branch of the U.S. armed forces be used to cover expenses associated with developing, managing and operating the applicable MFC, and (c) specifies the prescribed rate of return for each said private sector entity.

14. The method as in claim 1, wherein the branch of the U.S. armed forces is an owner of the LLE.

15. The method as in claim 1, wherein the real-property interest is obtained as an in-kind contribution of property by the branch of the U.S. armed forces.

16. The method as in claim 1, wherein the correlation between the income allocated to each said private sector entity and the actual amount of income distributed to each said private sector entity is 1:1.

17. In response to a request for qualifications issued in connection with a military housing privatization initiative in which the development, management and ownership of one or more military housing communities (MFC) on a parcel of land is to be privatized, including housing for occupancy primarily by N service personnel of a branch of the U.S. armed forces, a community development and management plan (CDMP) comprising:
a) the formation of a limited liability entity (LLE) having at least two owners including the branch of the U.S. armed forces and at least one private sector entity;
b) the allocation to the each said private sector entity a percentage of any income collected by the LLE, the percentage correlating directly with an actual amount of income distributed to each said one private sector entity;
b) the provision to the LLE of a real-property interest in the parcel and any improvements thereto;
c) the capitalizing of the LLE with at least one of cash and an in-kind contribution from each of the owners;
d) the collection as income to the LLE a basic allowance for housing (BAH) for each of the N service personnel that shall occupy the housing in the MFC; and
e) the recovery of expenses associated with development and management of the MFC included on the parcel using a portion of any undistributed income.

18. The method as in claim 17, wherein the LLE is a pass-through entity for minimizing tax consequences in privatizing the applicable MFC.

19. The method as in claim 17, wherein the branch of the U.S. armed forces is an owner of the LLE.

20. The method as in claim 17, wherein the real-property interest is obtained as an in-kind contribution of property by the branch of the U.S. armed forces.
